(19) United States
(12) Patent Application Publication
(10) Pub. No.: US 2022/0172251 A1
(43) Pub. Date: Jun. 2, 2022

(54) SYSTEM FOR ON-DEMAND ADVERTISING

(71) Applicant: Welect GmbH, Düsseldorf (DE)

(72) Inventors: Olaf Peters-Kim, Düsseldorf (DE); Philipp Dommers, Düsseldorf (DE)

(21) Appl. No.: 17/108,978

(22) Filed: Dec. 1, 2020

(51) Int. Cl. G06Q 30/02; H04L 29/06; H04W 4/23

(52) U.S. Cl. CPC G06Q 30/0257; H04L 65/80; G06Q 30/0277; H04W 4/23; H04L 65/4092

(57) ABSTRACT

A method including identifying a functionality available during a session between a publishing server and a consumer, wherein the consumer communicates with the publishing server using a client device is provided. The method includes providing multiple digital contents by at least one third party to the client device for display to the consumer within the session, based on a session parameter and providing, to the client device, a plugin script to display a digital content selected by the consumer from the multiple digital contents. The method also includes providing a button in the digital content for selection by the consumer, the button comprising a link to open a new tab in the client device and providing a token to the publishing server when the digital content has been viewed by the consumer in the client device. A system and a non-transitory, computer-readable medium storing instructions to perform the above method are also provided.

### BACKGROUND

### Field

The present disclosure generally relates to methods and systems to provide on-demand advertising payloads for uses of a network publishing server or a media content provider. More specifically, embodiments as disclosed herein are related to advertisement engines that provide a menu of advertisement options for a consumer to choose from, wherein the menu is based on consumer preferences and likelihood of success of the advertisement.

### Description of the Related Art

Consumer brands lose about one-third of their consumers every year due mainly to the inefficient advertising techniques typically oriented towards market segmentation through demographics. Furthermore, the efficiency of ad-targeting technologies will decrease due to increasing global data protection laws (e.g., CCPA, GDPR in Europe) and browser companies banning the use of third party cookies. To improve efficiency, marketing tools available today involve a trade-off between sophistication, selectivity, scalability, and accessibility (e.g., mobile, online, or in store). However, many of the marketing tools available today require a consumer to watch or listen to an unwanted advertisement down stream for at least a minimum amount of time. Even when the consumer is interested in the product, he or she may simply not desire to watch a product commercial at a time selected by the advertising agent or the media content provider.

### SUMMARY

In one embodiment of the present disclosure, a computer-implemented method includes identifying a functionality available during a session between a publishing server and a consumer, wherein the consumer communicates with the publishing server using a client device. The computer-implemented method also includes providing multiple digital contents by at least one third party to the publishing server for display to the consumer within the session, based on a session parameter, and providing, to the client device, a plugin script to display a digital content selected by the consumer from the multiple digital contents. The computer-implemented method also includes providing a button in the digital content for selection by the consumer, the button comprising a link to open a new tab in the client device, and providing a token to the publishing server when the digital content has been downloaded by the consumer in the client device.

According to one embodiment, a system is described that includes a processor and a memory coupled with the processor, the memory including instructions that, when executed by the one or more processors, cause the processor to identify a functionality available during a session between a publishing server and a consumer, wherein the consumer communicates with the publishing server using a client device. The processor also executes instructions to provide multiple digital contents by at least one third party to the publishing server for display to the consumer within the session, based on a session parameter, and to provide, to the client device, a plugin script to display a digital content selected by the consumer from the multiple digital contents. The processor also executes instructions to provide a button in the digital content for selection by the consumer, the button comprising a link to open a new tab in the client device, and to provide a token to the publishing server when the digital content has been viewed by the consumer in the client device.

According to one embodiment, a non-transitory, machine-readable medium is described that includes instructions, which when executed by one or more processors, cause a computer to perform a method that includes identifying a functionality available during a session between a publishing server and a consumer, wherein the consumer communicates with the publishing server using a client device. The method also includes providing multiple digital contents by at least one third party to the publishing server for display to the consumer within the session, based on a session parameter, and providing, to the client device, a plugin script to display a digital content selected by the consumer from the multiple digital contents. The method also includes providing a button in the digital content for selection by the consumer, the button comprising a link to open a new tab in the client device and providing a token to the publishing server when the digital content has been viewed by the consumer in the client device.

In yet another embodiment, a system is described that includes a means for storing commands and a means for executing the commands causing the system to perform a method that includes identifying a functionality available during a session between a publishing server and a consumer, wherein the consumer communicates with the publishing server using a client device. The method also includes providing multiple digital contents by at least one third party to the publishing server for display to the consumer within the session, based on a session parameter, and providing, to the client device, a plugin script to display a digital content selected by the consumer from the multiple digital contents. The method also includes providing a button in the digital content for selection by the consumer, the button comprising a link to open a new tab in the client device and providing a token to the publishing server when the digital content has been viewed by the consumer in the client device.

In a further embodiment, a computer-implemented method is described for identifying a user in a session with a publishing server and selecting multiple advertisement payloads by at least one third party for the user based on a purchasing history of the user stored in a database and on a session parameter. The computer-implemented method also includes determining a rank for the advertisement payloads on a likelihood that the user will consume an advertisement payload during the session and forming a sorted list of advertisement payloads based on the rank and on the session parameter. The computer-implemented method also includes forming a control widget to enable the user handling of the advertisement payload and providing a digital content to a publisher server, the digital content including the sorted list of advertisement payloads, the control widget, and a plugin button to link the user with a target website of an advertiser.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

The accompanying drawings, which are included to provide further understanding and are incorporated in and constitute a part of this specification, illustrate disclosed embodiments and together with the description serve to explain the principles of the disclosed embodiments. In the drawings:

FIG. 1 illustrates an example architecture for on-demand advertising, according to some embodiments.

FIG. 2 is a block diagram illustrating an example server and client from the architecture of FIG. 1, according to certain aspects of the disclosure.

FIG. 3 illustrates a system including a mobile device and at least one network server, configured to provide a playlist of personalized digital advertisements, promotions and offers to the consumer of the mobile device, according to some embodiments.

FIG. 4 illustrates a sequence of screenshots for an on-demand advertising platform interacting with a user from a desktop application, according to some embodiments.

FIG. 5 illustrates a menu for on-demand advertising selection provided via a desktop application, according to some embodiments.

FIG. 6 illustrates a sequence of screenshots for an on-demand advertising platform interacting with a user from a mobile application, according to some embodiments.

FIG. 7 is a flow chart illustrating steps in a method for providing a menu of advertising options to a consumer, according to some embodiments.

FIG. 8 is a flow chart illustrating steps in a method for selecting a menu with multiple advertising options for a consumer, according to some embodiments.

FIG. 9 is a block diagram illustrating an example computer system with which the client and server of FIGS. 1 and 2 and the methods of FIGS. 7 and 8 can be implemented.

In the figures, elements and steps denoted by the same or similar reference numerals are associated with the same or similar elements and steps, unless indicated otherwise.

### DETAILED DESCRIPTION

In the following detailed description, numerous specific details are set forth to provide a full understanding of the present disclosure. It will be apparent, however, to one ordinarily skilled in the art, that embodiments of the present disclosure may be practiced without some of these specific details. In other instances, well-known structures and techniques have not been shown in detail so as not to obscure the disclosure.

General Overview

Currently advertising techniques impose digital content on consumers, typically when consumers are downloading or down-streaming a multimedia file of interest. Consumers do not have the possibility to choose which advertising is relevant to them in that moment. Accordingly, consumers feel annoyed/disturbed by advertising, typically generating a negative reaction to the product or service being advertised. Moreover, in many instances, a consumer may be repeatedly disturbed by the same advertising, when accessing a certain web page or application commonly visited by the consumer. This tends to exacerbate the negative reaction of the consumer to the advertisement.

Many advertisements currently imposed on the consumer are selected by a publisher or Advertisement Technology providers on the basis of data from the customer which they collect from third party cookies on consumers' devices or other data resources for identification. However, many countries have implemented data protection laws/rules (CCPA, GDPR, and the like) which block the use of such data identification methods. To overcome this problem arising in the technological field of computer networking, embodiments as disclosed herein apply the technological solution of on-demand advertising that protects consumers and their data as well as allows the advertising industry to deliver advertisements that are relevant to the consumer.

The disclosed system addresses this problem specifically arising in the realm of computer technology by providing a solution also rooted in computer technology, namely, by an application implemented within the publisher server application or website allowing customers, users, readers, and the like to be able to choose which advertising payload they want to consume. In some embodiments, when consumers select an advertising video spot by clicking on one of the banners of an Ad-Chooser widget, and an Ad-Player widget wherein the video advertising is played. In some embodiments, when the advertising payload is complete, the consumer may continue down-streaming the content on the publisher server application or website.

In embodiments consistent with the present disclosure, the Ad-Chooser widget also ensures to provide a varied assortment of advertising options to the consumer, based on prior consumer interests, purchase, lifestyle, and prior advertisement selections. This feature enhances the consumer interaction with the advertisements, and keeps the consumer interest in downloading at least one of the advertisement payloads.

The subject system provides several advantages, including providing an engine that enables tracking the consumer interaction with the advertisement payload via an Ad-Tracker widget or script included in the Ad-Chooser widget or the Ad-Player widget. Accordingly, embodiments as disclosed herein may provide to the content provider server, the advertising provider server, or the advertiser (e.g., a retailer or brand manufacturer advertising a product, a government, a service provider, and the like), real-time and accurate information regarding the effectiveness of an advertising campaign.

Although many examples provided herein describe a consumer's search inputs or purchasing history being identifiable, or download history for images being stored, each consumer may grant explicit permission for such consumer information to be shared or stored. The explicit permission may be granted using privacy controls integrated into the disclosed system. Each consumer may be provided notice that such consumer information will be shared with explicit consent, and each consumer may at any time terminate the information sharing, and may delete any stored consumer information. The stored consumer information may be encrypted to protect consumer security. For this purpose, a server as disclosed herein may include an IAB TCF-API to read consumer's privacy settings when the consumers has selected these settings on the publishers Website already.

Example System Architecture

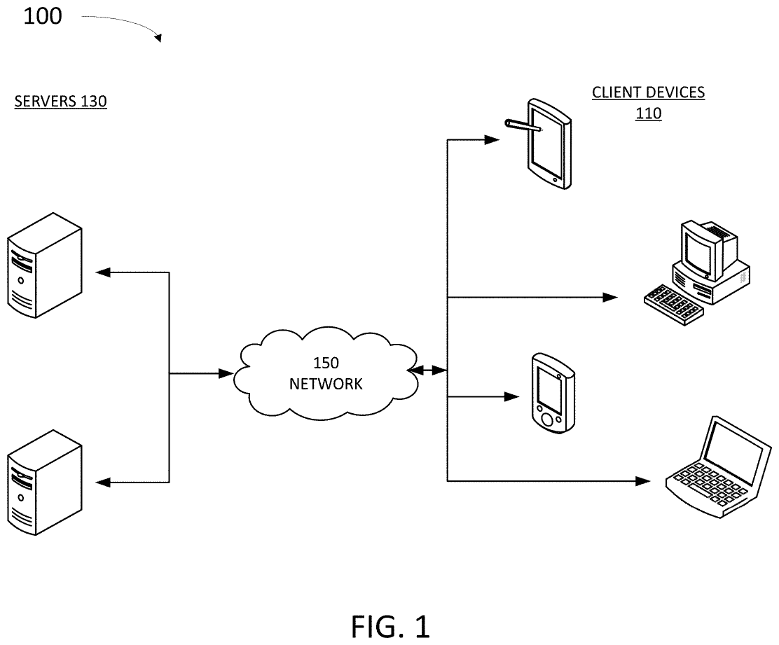

FIG. 1 illustrates an example architecture 100 for a system for on-demand advertising suitable for practicing some implementations of the disclosure. Architecture 100 includes servers 130 and client devices 110 coupled over a network 150. One of the many servers 130 is configured to host a memory, including instructions which, when executed by a processor, cause the server 130 to perform at least some of the steps in methods as disclosed herein. In some embodiments, architecture 100 is configured to present a menu with multiple digital promotions and advertisements to a consumer, who may be the user of client device 110. In some embodiments, when a consumer data is available, the digital content provided to the consumer may be selected based on a purchase history of the consumer, which may be stored in a history log in a memory of the server, or in a database communicatively coupled with network 150.

Servers 130 may include any device having an appropriate processor, memory, and communications capability for hosting the history log, an advertisement payload database, and an advertisement engine. The advertisement engine may be accessible by various clients 110 over the network 150. In some embodiments, servers 130 may include a digital advertisement server, a publisher, or supply side platform (SSP) server, and a demand side platform (DSP) server. Client devices 110 may include, for example, desktop computers, mobile computers, tablet computers (e.g., including e-book readers), mobile devices (e.g., a smartphone or PDA), or any other devices having appropriate processor, memory, and communications capabilities for accessing the history log on one or more of servers 130 or a database. Network 150 can include, for example, any one or more of a local area network (LAN), a wide area network (WAN), the Internet, and the like. Further, network 150 can include, but is not limited to, any one or more of the following network topologies, including a bus network, a star network, a ring network, a mesh network, a star-bus network, tree or hierarchical network, and the like.

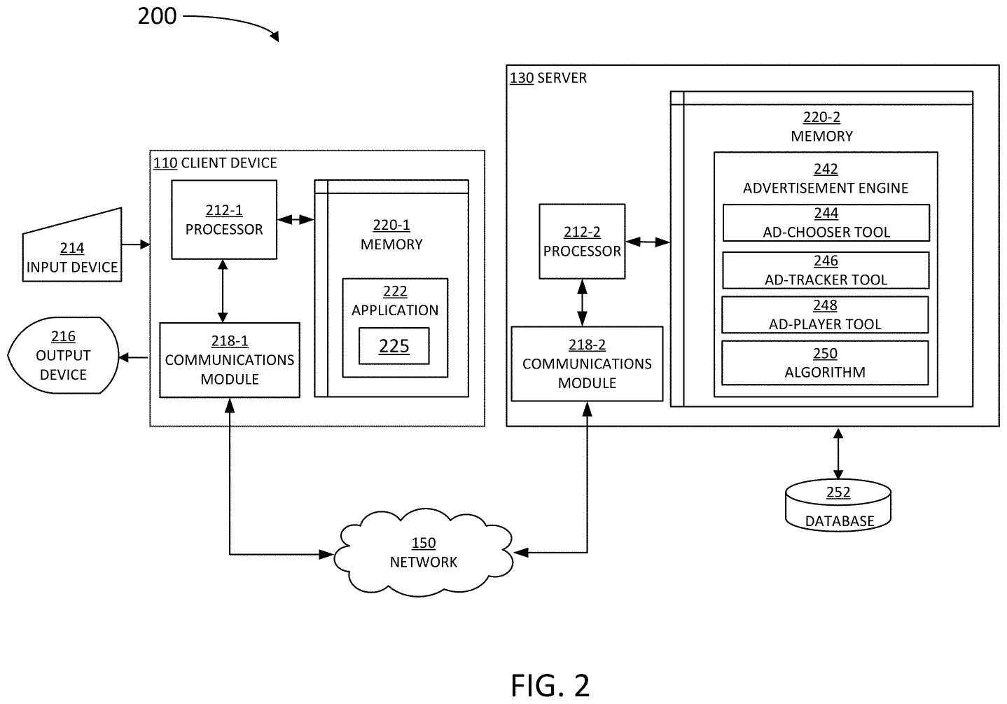

FIG. 2 is a block diagram 200 illustrating an example server 130 and client device 110 in the architecture 100 of FIG. 1, according to certain aspects of the disclosure. Client device 110 and server 130 are communicatively coupled over network 150 via respective communications modules 218-1 and 218-2 (hereinafter, collectively referred to as “communications modules 218”). Communications modules 218 are configured to interface with network 150 to send and receive information, such as data, requests, responses, and commands to other devices on the network. Communications modules 218 can be, for example, modems or Ethernet cards. Client device 110 may be coupled with an input device 214 and with an output device 216. Input device 214 may include a keyboard, a mouse, a pointer, or even a touch-screen display that a consumer may use to interact with client device 110. Likewise, output device 216 may include a display and a speaker with which the consumer may retrieve results from client device 110. Client device 110 may also include a processor 212-1, configured to execute instructions stored in a memory 220-1, and to cause client device 110 to perform at least some of the steps in methods consistent with the present disclosure. Memory 220-1 may further include an application 222, including specific instructions which, when executed by processor 212, cause a digital content 225 (e.g., provided remotely by server 130) to be displayed for the consumer. Digital content 225 may include multiple digital advertisements, promotions or coupons presented to the consumer by server 130, and the consumer may store at least some of the digital promotions or coupons from digital content 225 in memory 220-1.

Application 222 may be configured to display a digital content 225 in output device 216. Application 222 may be installed in memory 220-1 by the manufacturer, together with the installation of an operating system that controls all hardware operations of client device 110. Moreover, in some embodiments, a consumer may download application 222 in client device 110 to display the advertisement. Application 222 may include a video player that is downloaded from network 150 either as part of a publisher server or by an advertisement engine Server.

Server 130 includes a memory 220-2, a processor 212-2, and a communications module 218-2. Processor 212-2 is configured to execute instructions, such as instructions physically coded into processor 212-2, instructions received from software in memory 220-2, or a combination of both. Memory 220-2 includes an advertisement engine 242 for integrating images, videos, text (Head- and Sublines as well as descriptions and captions) and other multimedia files stored in a database 252 into a digital content 225. Advertisement engine 242 may push digital advertisements from database 252 to a consumer of client device 110 that is a consumer of a publisher site through application 222 or a web browser installed in client device 110. Accordingly, application 222 may be installed by server 130 and perform scripts and other routines provided by server 130. In some embodiments, application 222 may be configured to display digital content 225 provided by advertisement engine 242. Hereinafter, memories 220-1 and 220-2 and processors 212-1 and 212-2 will be collectively referred to as “memories 220” and “processors 212,” respectively.

Advertisement engine 242 integrates digital content 225 based on information retrieved from available advertising budgets stored in a database 252. Advertisement engine 242 may include an Ad-Chooser tool 244. Ad-Chooser tool 244 hosts a panel of multiple advertisement payloads in digital content 225 to be displayed by application 222 in output device 216. In some embodiments, Ad-Chooser tool 244 may display multiple thumbnails of media files as well as Headline, subline and descriptions of the advertisements including advertisements in output device 216 (e.g., when application 222 is a browser application and client device 110 is a desktop device or a laptop device). In some embodiments, Ad-Chooser tool 244 is configured to maximize the level of novelty of the advertisement payloads provided to the consumer. For example, in some embodiments, Ad-Chooser tool 244 may weigh different advertisement payloads based on the number of times any given advertisement payload has been presented to the consumer (e.g., the fewer number of times, the higher the weight).

In some embodiments, Ad-Chooser tool 244 may display a slidable ‘deck’ of media files including advertisements in output device 216 that the consumer may flip through with a sliding finger (e.g., when application 222 is a mobile device application and client device 110 is a portable phone, smartphone, or tablet). Advertisement engine 242 may also include an Ad-Tracker tool 246. Ad-Tracker tool 246 is configured to include a script in digital content 225 that triggers a signal to advertisement engine 242 when the user interacts with digital content 225, or with a specific advertisement payload therein. In some embodiments, advertisement engine 242 may also include an Ad-Player tool 248, configured to control the display of digital content 225 in client device 110. In some embodiments, Ad-Player tool 248 may include a plugin script configured to display buttons (e.g., click to act buttons, and the like) and other control commands in a widget included in digital content 225. For example, in some embodiments, a plugin script provided by Ad-Chooser tool 244 or Ad-Tracker tool 246 may be configured to execute a short frame sequence for a preview of an advertisement payload, for the consumer.

Database 252 includes the purchase history of multiple consumers listed according to a consumer identification. In some embodiments, database 252 also includes a consumed advertising history for multiple consumers. To achieve this, in some embodiments, an algorithm 250 stores commands which, when executed by processor 212-2, causes server 130 to integrate digital content 225. Algorithm 250 may include a neural network (NN) trained over the history log in database 252, to select digital content 225 targeted to the specific preferences of a consumer when the consumer uses any one of applications 222 to access a network site hosted by server 130 (e.g., an SSP server). Accordingly, the SSP server hosting the network site accessed through application 222 may be different from a DSP server hosting advertisement engine 242.

Database 252 may include a list of frequent consumers of one or multiple advertisers. Advertisement engine 242 may create, update, and maintain database 252 with consumer identification data, and purchase history data. In that regard, advertising engine 242 may be hosted by a DSP server or a dynamic rendering server. Accordingly, the DSP server may have access to one or more digital promotion databases, to one or more consumer identification databases, and to one or more history log databases, all within databases 252, through business agreements with one or more partners.

In certain aspects, processor 212-2 in a server 130 hosted by a DSP or data management platform (DMP) database is configured to determine data for a purchase history log in database 252 by obtaining consumer purchasing data identifying the consumer via the frequent shopper identification used at multiple purchasing events in multiple locations, over a pre-selected span of time. In some embodiments, database 252 includes online purchasing history for the consumer through application 222 or a network browser.

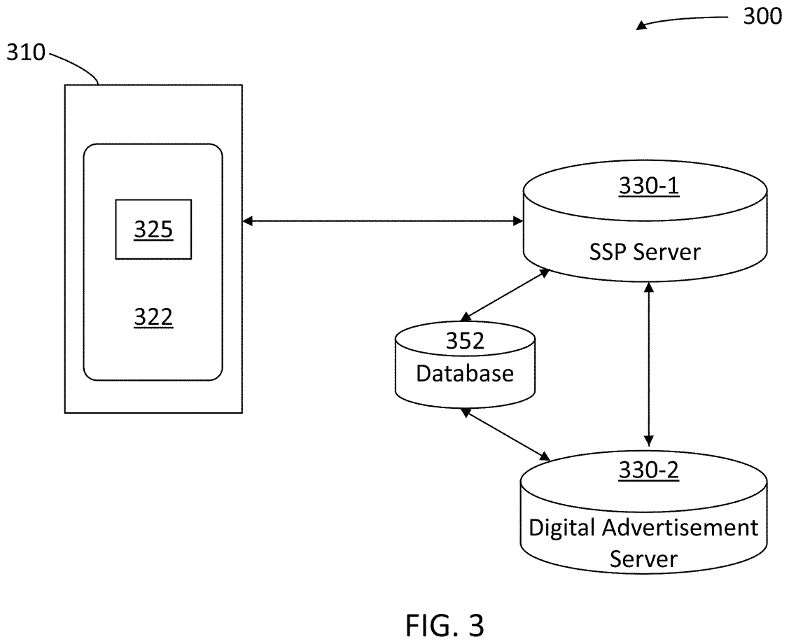

FIG. 3 illustrates a system 300, including a client device 310, an SSP server 330-1, and a digital advertisement server 330-2 (hereinafter, collectively referred to as “servers 330”), according to some embodiments. SSP server 330-1 is configured to provide a digital content 325 in an application 322 running on client device 310 used by the consumer. Servers 330 and client device 310 may include a memory and a processor, wherein the memory may include, or may have access to, a database 352. Database 352 may include data linking the consumer to a historic list of purchased products or items. In some embodiments, client device 310 may include a desktop or laptop computer, and application 322 may be a browser application running in the desktop or laptop computer. In some embodiments, client device 310 may be a mobile computer (e.g., a smart phone, tablet device, and the like), and application 322 may be a mobile application.

Digital advertisement server 330-2 may include a platform configured to receive a digital content from a brand manufacturer, a retailer, a service provider, and the like. For example, in some embodiments, a brand manufacturer may decide to promote a campaign for a certain CPG, or multiple CPGs. Accordingly, the brand manufacturer pushes at least one advertisement to server 330-2 for inclusion within digital content 325. The advertisement may include a banner advertisement, a promotional video or any other streaming media file for selected CPGs from the brand manufacturer. In some embodiments, digital advertisement server 330-2 is configured to generate the digital content according to a session parameter between SSP server 330-1 and the consumer through client device 310. This may include processing certain logic steps, including neural networking algorithms and other techniques, executed by a processor in digital advertisement server 330-2.

In some embodiments, SSP server 330-1 includes a link in digital content 325 which loads a menu of advertisements for the consumer selection, prepared by digital advertisement server 330-2. In some embodiments, digital content 325 communicates with digital advertisement server 330-2 to determine if and what functionality is run by application 322. Application 322 loads multiple digital contents from digital advertisement server 330-2 (banner image, headline, subline). In some embodiments, digital advertisement server 330-2 provides multiple advertisements according to best suitability for the respective session of the application. In some embodiments, application 322 includes an “Ad-Chooser” widget hosted by an Ad-Chooser tool in any one of servers 330 (e.g., Ad-Chooser tool 244). The Ad-Chooser widget displays various ad-campaigns for the consumer on the display of client device 310. In some embodiments, the contents of the Ad-Chooser widget may be arranged or sorted by SSP server 330-1. In some embodiments, the order and amount of advertisements displayed to the consumer is selected by digital advertisement server 330-2 according to the likelihood that the consumer will view the advertisement and act upon it.

In some embodiments, application 322 may display an advertisement or digital content from SSP server 330-1 once the user has selected one. In some embodiments, application 322 sets up a Video-Player tool on the display of client device 310 when the digital content includes a video or other multimedia file. Moreover, in some embodiments, application 322 displays “call-to-action” (CTA) buttons to the user which, when clicked, open a target universal resource locator (URL) on a new tab. The buttons may be provided by digital advertisement server 330-2, as an addition to the advertisement in the digital content (e.g., via a video ad serving template, VAST). In some embodiments, the buttons may include customizable elements and a separate step for the consumer while consuming the digital content in the advertisement. In some embodiments, application 322 provides data to digital advertisement server 330-2 monitoring the delivery and completion of digital content 325. Application 322 closes digital content 325 after it has been displayed and consumed.

In some embodiments, digital advertisement server 330-2 provides a token based video-player/paywall/ad wall service which allows SSP server 330-1 to check for completed video views by a consumer. Application 322 monitors the ad consumption and provides monitoring information to digital advertisement server 330-2. In some embodiments, application 322 sends a signal (e.g., a token, and the like) to the specific advertisers chosen by the consumer using an Ad-Tracking tool.

In some embodiments, an advertisement payload in digital content 325 is requested from the video player or application 322 in mobile device 310 directly to advertisement server 330-2 once the consumer has selected a specific advertisement content, without being redirected via SSP server 330-1. In some embodiments, the request from application 322 may be redirected via SSP server 330-1.

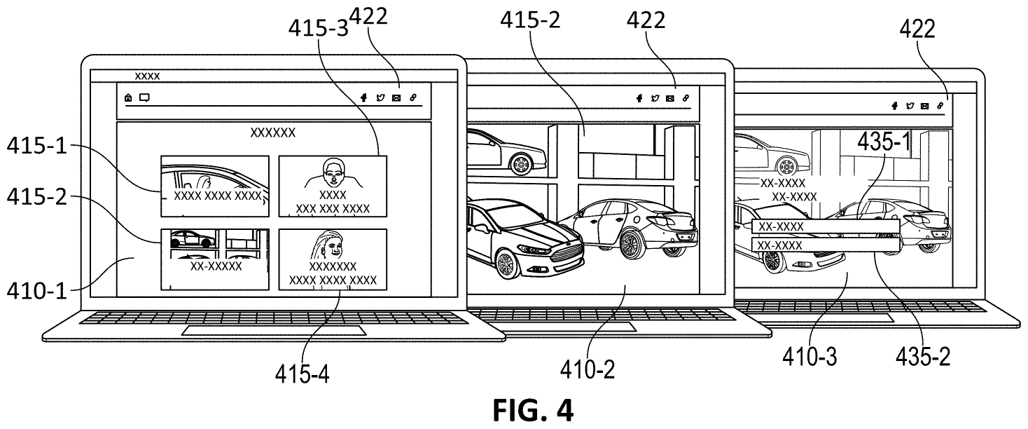

FIG. 4 illustrates a sequence of screenshots 410-1, 410-2, and 410-3 (hereinafter, collectively referred to as “screenshots 410”) for an on-demand advertising platform interacting with a user via a desktop application 422, according to some embodiments. Desktop application 422 may include, for example, a web browser.

Screenshot 410-1 illustrates a view of an Ad-Chooser panel including at least four different advertisement payloads 415-1, 415-2, 415-3, and 415-4, via respective thumbnails (hereinafter, collectively referred to as “advertisement payloads 415”). Screenshot 410-2 illustrates that the consumer has selected advertisement payload 415-2 and therefore the screen displays the image, video, or any other content in advertisement payload 415-2 to the consumer. As advertisement payload 415-2 completes a display or a full video view, click to act “CTA” buttons 435-1 and 435-2 are displayed in screenshot 410-3 (hereinafter, collectively referred to as “CTA buttons 435”). When the consumer executes any one of CTA buttons 435, a link may take the consumer to a website hosted by the retailer, vendor or advertiser associated with advertisement payload 415-2.

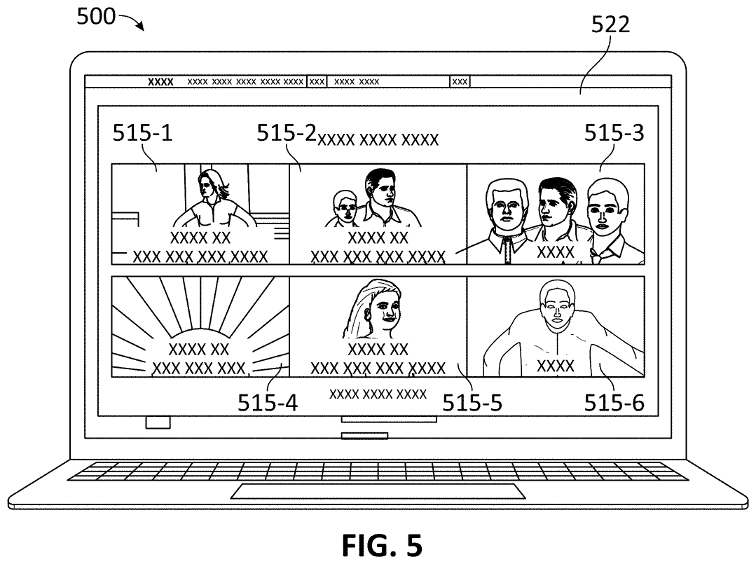

FIG. 5 illustrates a menu 500 for on-demand advertising selection provided via a desktop application 522, according to some embodiments. Menu 500 illustrates multiple advertisement payloads 515-1, 515-2, 515-3, 515-4, 515-5, and 515-6 (hereinafter, collectively referred to as “advertisement payloads 515”). Advertisement payloads 515 may be shown as thumbnails which, when the consumer hovers a mouse or a pointer over any given thumbnail, may display a quick sequence of screenshots in a shortened video sequence as a preview of the advertisement.

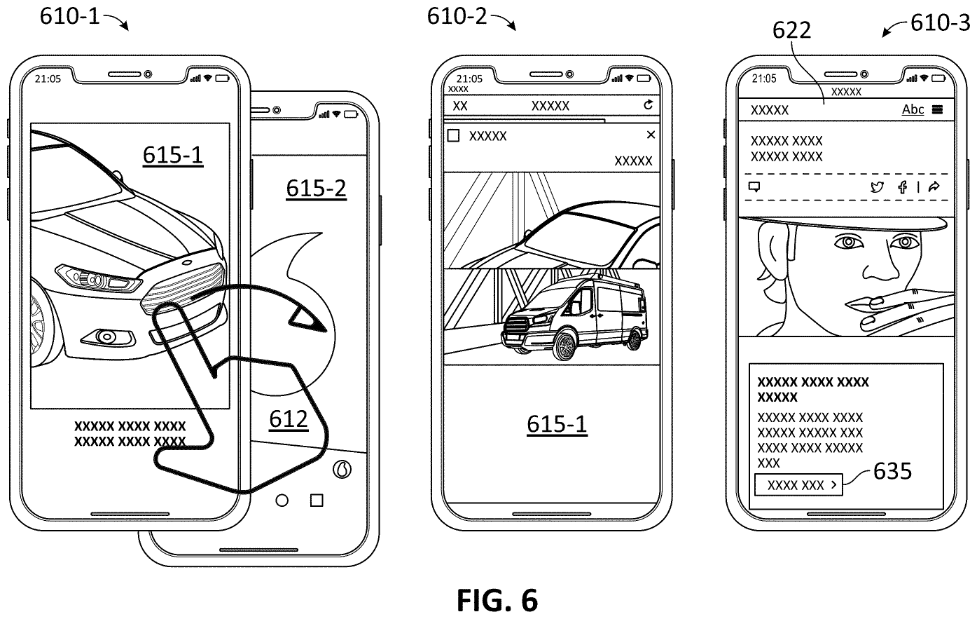

FIG. 6 illustrates a sequence of screenshots 610-1, 610-2, and 610-3 (hereinafter, collectively referred to as “screenshots 610”), for an on-demand advertising platform interacting with a user via a mobile application 622, according to some embodiments. In screenshot 610-1, a digital content includes advertisement payload 615-1 that the consumer may flip via a finger swipe 612 onto advertisement payload 615-2. Hereinafter, advertisement payloads 615-1 and 615-2 will be collectively referred to as “advertisement payloads 615.” The consumer may choose advertisement payload 615-1 and screenshot 610-2 displays the advertisement in full view. Screenshot 610-3 displays an action button 635 that will direct the consumer to an application hosted by the retailer or vendor that owns advertisement payload 615-1.

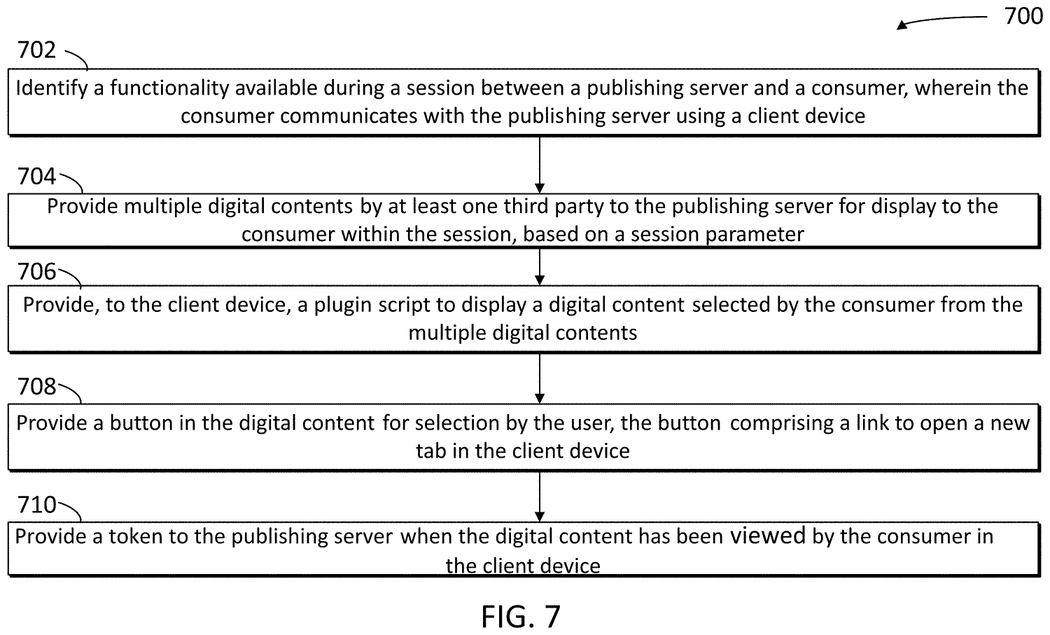

FIG. 7 illustrates steps in a method 700 for providing a menu of advertising options to a consumer, according to some embodiments. Method 700 may be performed at least partially by any one of a plurality of servers (e.g., servers 130 or 330). For example, at least some of the steps in method 700 may be performed by a client device executing code for a browser and an application to access a publisher website (e.g., client devices 110 and 310, and applications 222 and 322, including a mobile application installed in client device 110). The application may be hosted by an advertisement engine in a digital advertisement server that processes logic to create a digital content and to push the digital content to the client device (cf. advertisement engine 242 and digital advertisement server 330-2). The system also includes a publisher server that requests digital ad-calls from the on-demand advertisement server (e.g., SSP server 330-1). One or more of the servers may host an Ad-Chooser tool to include a widget in the application so that the consumer may select a desired digital content (e.g., Ad-Chooser tool 244). Moreover, one or more of the servers may host an Ad-Tracker tool in the application that sends a message to one or more of the servers when the consumer has chosen a specific digital content or advertisement (e.g., Ad-Tracker tool 246). Accordingly, at least some of the steps in method 700 may be performed by a processor executing commands stored in a memory of the server or the mobile device, or accessible by the server or the mobile device (e.g., processors 212 and memories 220). Further, in some embodiments, at least some of the steps in method 700 may be performed overlapping in time, almost simultaneously, or in a different order from the order illustrated in method 700. Moreover, a method consistent with some embodiments disclosed herein may include at least one, but not all, of the steps in method 700.

Step 702 includes identifying a functionality available during a session between a publishing server and a consumer, wherein the consumer communicates with the publishing server using a client device. In some embodiments, step 702 includes identifying at least one of a mobile device application, a desktop application, or a browser application running in the client device.

Step 704 includes providing multiple digital contents to the publishing server for display to the consumer within the session, based on a session parameter. In some embodiments, step 704 includes providing at least one of a banner image, a headline, a subline, an audio stream, or a video stream. In some embodiments, step 704 includes sorting the digital contents according to a likelihood that the consumer will view the digital content in full. In some embodiments, the session parameter comprises a time, a season, and a demographic information about the consumer, and step 704 includes selecting a media file based on the time, the season, and the demographic information about the consumer. In some embodiments, the session parameter comprises a caption of a session context, and step 704 includes searching for the digital content with the caption. In some embodiments, step 704 includes verifying that none of the digital contents provided to the consumer are repeated from a previous rendition of advertisement payloads to the consumer, or only repeated a number of times not to exceed a pre-selected (e.g., by the advertiser) frequency cap. In some embodiments, step 704 may include verifying that at least one of the digital contents provided to the consumer includes an advertisement payload that is new to the consumer.

Step 706 includes providing, to the client device, a plugin script to display a digital content selected by the consumer from the multiple digital contents. In some embodiments, step 706 includes providing a video control including a play button, a pause button, and a stop button.

Step 708 includes providing a button in the digital content for selection by the consumer, the button comprising a link to open a new tab in the client device.

Step 710 includes providing a token to the client device when the digital content has been viewed by the consumer in the client device. In some embodiments, step 710 includes providing a token to the publishing server when the content has been viewed by the consumer in the client device. In some embodiments, step 710 includes providing a token to an advertiser who owns the digital content, indicative that the consumer has viewed or consumed the digital content, when the consumer has agreed to this according to data protection settings selected by the consumer. In some embodiments, step 710 includes providing a token to an advertiser when the consumer activates the button in the digital content. In some embodiments, step 710 includes updating an algorithm for selecting the digital contents with the session parameter when the consumer has viewed or consumed the digital content.

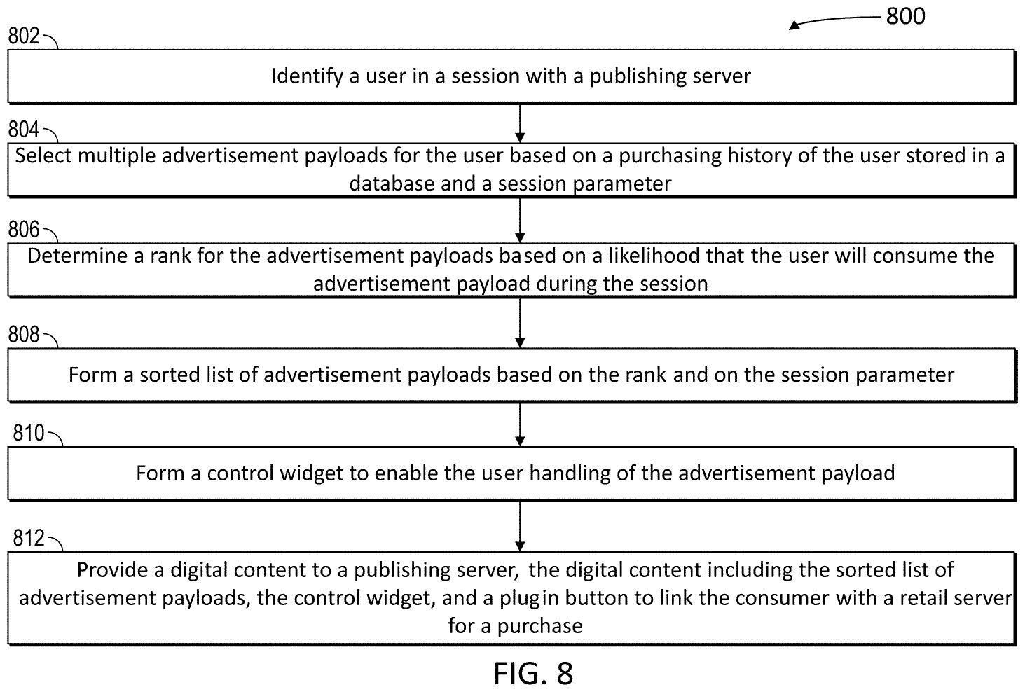

FIG. 8 illustrates steps in a method 800 for selecting a menu with multiple advertising options for a consumer, according to some embodiments. Method 800 may be performed at least partially by any one of a plurality of servers (e.g., servers 130 or 330). For example, at least some of the steps in method 800 may be performed by a client device executing code for a browser and an application to access a publisher website (e.g., client devices 110 and 310, and applications 222 and 322). The application may be hosted by an advertisement engine in a digital advertisement server that processes logic to create a digital content and to push the digital content to the client device (cf. advertisement engine 242 and digital advertisement server 330-2). The system also includes a publisher server that requests digital advertisement bids from the digital advertisement server (e.g., SSP server 330-1). One or more of the servers may host an Ad-Chooser tool to include a widget in the application so that the consumer may select a desired digital content (e.g., Ad-Chooser tool 244). Moreover, one or more of the servers may host an Ad-Tracker tool in the application that sends a message to one or more of the servers when the consumer has chosen a specific digital content or advertisement (e.g., Ad-Tracker tool 246). Accordingly, at least some of the steps in method 800 may be performed by a processor executing commands stored in a memory of the server or the mobile device, or accessible by the server or the mobile device (e.g., processors 212 and memories 220). Further, in some embodiments, at least some of the steps in method 800 may be performed overlapping in time, almost simultaneously, or in a different order from the order illustrated in method 800. Moreover, a method consistent with some embodiments disclosed herein may include at least one, but not all, of the steps in method 800.

Step 802 includes identifying a user in a session with a publishing server.

Step 804 includes selecting multiple advertisement payloads for the user based on a purchasing history of the user stored in a database and on a session parameter. In some embodiments, step 804 includes selecting one or more of the advertisement payloads based on available advertisements for display, the budget for the advertisement, and a consumed advertising history. In some embodiments, the session parameter is indicative of whether the session is running a mobile application or a browser in a desktop device and step 804 includes selecting the advertisement payloads for display in the mobile application or in the desktop device based on the session parameter. In some embodiments, the session parameter is indicative of display features in a client device handled by the user, and step 804 includes selecting an advertisement payload that is compatible with the display features in the client device.

Step 806 includes determining a rank for the advertisement payloads on a likelihood that the user will consume the advertisement payload during the session.

Step 808 includes forming a sorted list of advertisement payloads based on the rank and on the session parameter. In some embodiments, step 808 includes adding a button for display to the user, wherein the button includes a link to a resource location for a vendor associated with the advertisement payload.

Step 810 includes forming a control widget to enable the user handling of the advertisement payload.

Step 812 includes providing a digital content to a publisher server, the digital content including the sorted list of advertisement payloads, the control widget, and a plugin button to link the user with a target website (or mobile application) of the advertiser. In some embodiments, the session parameter includes a semantic context of the session, and step 812 further includes searching in a database for an advertisement payload based on the semantic context of the session. In some embodiments, step 812, further includes configuring the plugin button to provide a track signal indicative of an interaction between the user and the advertisement payload.

### Hardware Overview

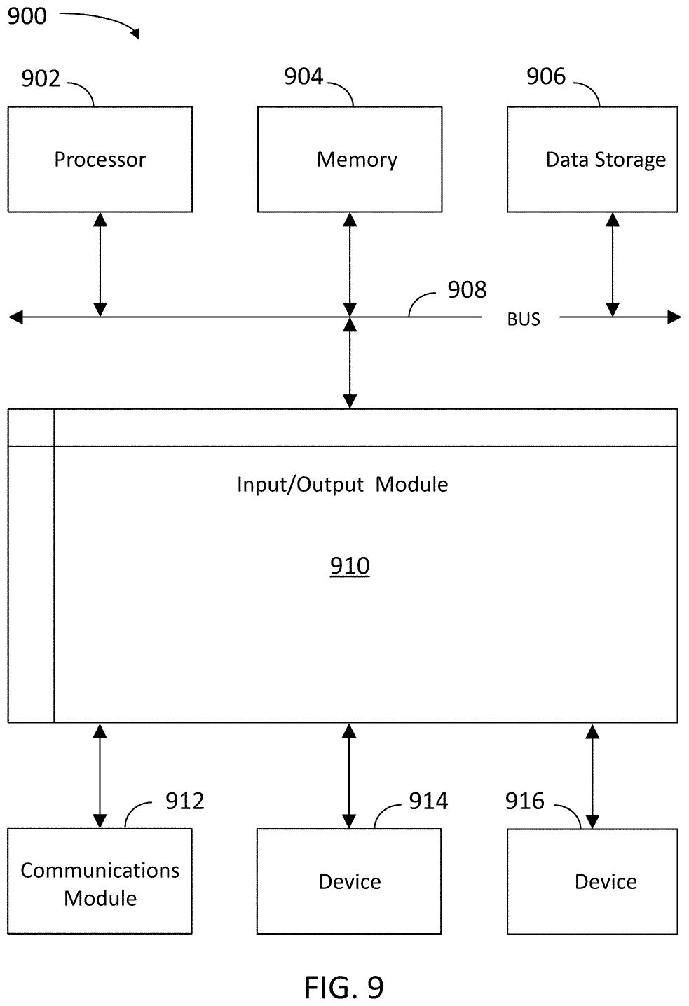

FIG. 9 is a block diagram illustrating an exemplary computer system 900 with which client device 110 and servers 130 of FIGS. 1 and 2, and the methods of FIGS. 7 and 8 can be implemented. In certain aspects, the computer system 900 may be implemented using hardware or a combination of software and hardware, either in a dedicated server, or integrated into another entity, or distributed across multiple entities.

Computer system 900 (e.g., client device 110 and server 130) includes a bus 908 or other communication mechanism for communicating information, and a processor 902 (e.g., processors 212) coupled with bus 908 for processing information. By way of example, the computer system 900 may be implemented with one or more processors 902. Processor 902 may be a general-purpose microprocessor, a microcontroller, a Digital Signal Processor (DSP), an Application Specific Integrated Circuit (ASIC), a Field Programmable Gate Array (FPGA), a Programmable Logic Device (PLD), a controller, a state machine, gated logic, discrete hardware components, or any other suitable entity that can perform calculations or other manipulations of information.

Computer system 900 can include, in addition to hardware, code that creates an execution environment for the computer program in question, e.g., code that constitutes processor firmware, a protocol stack, a database management system, an operating system, or a combination of one or more of them stored in an included memory 904 (e.g., memories 220), such as a Random Access Memory (RAM), a flash memory, a Read-Only Memory (ROM), a Programmable Read-Only Memory (PROM), an Erasable PROM (EPROM), registers, a hard disk, a removable disk, a CD-ROM, a DVD, or any other suitable storage device, coupled with bus 908 for storing information and instructions to be executed by processor 902. The processor 902 and the memory 904 can be supplemented by, or incorporated in, special purpose logic circuitry.

The instructions may be stored in the memory 904 and implemented in one or more computer program products, e.g., one or more modules of computer program instructions encoded on a computer-readable medium for execution by, or to control the operation of, the computer system 900, and according to any method well known to those of skill in the art, including, but not limited to, computer languages such as data-oriented languages (e.g., SQL, dBase), system languages (e.g., C, Objective-C, C++, Assembly), architectural languages (e.g., Java, .NET), and application languages (e.g., PHP, Ruby, Perl, Python). Instructions may also be implemented in computer languages such as array languages, aspect-oriented languages, assembly languages, authoring languages, command line interface languages, compiled languages, concurrent languages, curly-bracket languages, dataflow languages, data-structured languages, declarative languages, esoteric languages, extension languages, fourth-generation languages, functional languages, interactive mode languages, interpreted languages, iterative languages, list-based languages, little languages, logic-based languages, machine languages, macro languages, metaprogramming languages, multiparadigm languages, numerical analysis, non-English-based languages, object-oriented class-based languages, object-oriented prototype-based languages, off-side rule languages, procedural languages, reflective languages, rule-based languages, scripting languages, stack-based languages, synchronous languages, syntax handling languages, visual languages, wirth languages, and xml-based languages. Memory 904 may also be used for storing temporary variable or other intermediate information during execution of instructions to be executed by processor 902.

A computer program as discussed herein does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program can be deployed to be executed on one computer or on multiple computers that are located at one site or distributed across multiple sites and intercoupled by a communication network. The processes and logic flows described in this specification can be performed by one or more programmable processors executing one or more computer programs to perform functions by operating on input data and generating output.

Computer system 900 further includes a data storage device 906 such as a magnetic disk or optical disk, coupled with bus 908 for storing information and instructions. Computer system 900 may be coupled via input/output module 910 to various devices. Input/output module 910 can be any input/output module. Exemplary input/output modules 910 include data ports such as USB ports. The input/output module 910 is configured to connect to a communications module 912. Exemplary communications modules 912 (e.g., communications modules 218) include networking interface cards, such as Ethernet cards and modems. In certain aspects, input/output module 910 is configured to connect to a plurality of devices, such as an input device 914 (e.g., input device 214) and/or an output device 916 (e.g., output device 216). Exemplary input devices 914 include a keyboard and a pointing device, e.g., a mouse or a trackball, by which a consumer can provide input to the computer system 900. Other kinds of input devices 914 can be used to provide for interaction with a consumer as well, such as a tactile input device, visual input device, audio input device, or brain-computer interface device. For example, feedback provided to the consumer can be any form of sensory feedback, e.g., visual feedback, auditory feedback, or tactile feedback; and input from the consumer can be received in any form, including acoustic, speech, tactile, or brain wave input. Exemplary output devices 916 include display devices, such as an LCD (liquid crystal display) monitor, for displaying information to the consumer.

According to one aspect of the present disclosure, the client device 110 and server 130 can be implemented using a computer system 900 in response to processor 902 executing one or more sequences of one or more instructions contained in memory 904. Such instructions may be read into memory 904 from another machine-readable medium, such as data storage device 906. Execution of the sequences of instructions contained in main memory 904 causes processor 902 to perform the process steps described herein. One or more processors in a multi-processing arrangement may also be employed to execute the sequences of instructions contained in memory 904. In alternative aspects, hard-wired circuitry may be used in place of or in combination with software instructions to implement various aspects of the present disclosure. Thus, aspects of the present disclosure are not limited to any specific combination of hardware circuitry and software.

Various aspects of the subject matter described in this specification can be implemented in a computing system that includes a back end component, e.g., a data server, or that includes a middleware component, e.g., an application server, or that includes a front end component, e.g., a client computer having a graphical consumer interface or a Web browser through which a consumer can interact with an implementation of the subject matter described in this specification, or any combination of one or more such back end, middleware, or front end components. The components of the system can be inter-coupled by any form or medium of digital data communication, e.g., a communication network. The communication network (e.g., network 150) can include, for example, any one or more of a LAN, a WAN, the Internet, and the like. Further, the communication network can include, but is not limited to, for example, any one or more of the following network topologies, including a bus network, a star network, a ring network, a mesh network, a star-bus network, tree or hierarchical network, or the like. The communications modules can be, for example, modems or Ethernet cards.

Computer system 900 can include clients and servers. A client and server are generally remote from each other and typically interact through a communication network. The relationship of client and server arises by virtue of computer programs running on the respective computers and having a client-server relationship to each other. Computer system 900 can be, for example, and without limitation, a desktop computer, laptop computer, or tablet computer. Computer system 900 can also be embedded in another device, for example, and without limitation, a mobile telephone, a PDA, a mobile audio player, a Global Positioning System (GPS) receiver, a video game console, and/or a television set top box.

The term “machine-readable storage medium” or “computer-readable medium” as used herein refers to any medium or media that participates in providing instructions to processor 902 for execution. Such a medium may take many forms, including, but not limited to, non-volatile media, volatile media, and transmission media. Non-volatile media include, for example, optical or magnetic disks, such as data storage device 906. Volatile media include dynamic memory, such as memory 904. Transmission media include coaxial cables, copper wire, and fiber optics, including the wires forming bus 908. Common forms of machine-readable media include, for example, floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH EPROM, any other memory chip or cartridge, or any other medium from which a computer can read. The machine-readable storage medium can be a machine-readable storage device, a machine-readable storage substrate, a memory device, a composition of matter affecting a machine-readable propagated signal, or a combination of one or more of them.

To illustrate the interchangeability of hardware and software, items such as the various illustrative blocks, modules, components, methods, operations, instructions, and algorithms have been described generally in terms of their functionality. Whether such functionality is implemented as hardware, software, or a combination of hardware and software depends upon the particular application and design constraints imposed on the overall system. Skilled artisans may implement the described functionality in varying ways for each particular application.

As used herein, the phrase “at least one of” preceding a series of items, with the terms “and” or “or” to separate any of the items, modifies the list as a whole, rather than each member of the list (e.g., each item). The phrase “at least one of” does not require selection of at least one item; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

The word “exemplary” is used herein to mean “serving as an example, instance, or illustration.” Any embodiment described herein as “exemplary” is not necessarily to be construed as preferred or advantageous over other embodiments. Phrases such as an aspect, the aspect, another aspect, some aspects, one or more aspects, an implementation, the implementation, another implementation, some implementations, one or more implementations, an embodiment, the embodiment, another embodiment, some embodiments, one or more embodiments, a configuration, the configuration, another configuration, some configurations, one or more configurations, the subject technology, the disclosure, the present disclosure, and other variations thereof and alike are for convenience and do not imply that a disclosure relating to such phrase(s) is essential to the subject technology or that such disclosure applies to all configurations of the subject technology. A disclosure relating to such phrase(s) may apply to all configurations, or one or more configurations. A disclosure relating to such phrase(s) may provide one or more examples. A phrase such as an aspect or some aspects may refer to one or more aspects and vice versa, and this applies similarly to other foregoing phrases.

A reference to an element in the singular is not intended to mean “one and only one” unless specifically stated, but rather “one or more.” The term “some” refers to one or more. Underlined and/or italicized headings and subheadings are used for convenience only, do not limit the subject technology, and are not referred to in connection with the interpretation of the description of the subject technology. Relational terms such as first and second and the like may be used to distinguish one entity or action from another without necessarily requiring or implying any actual such relationship or order between such entities or actions. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public, regardless of whether such disclosure is explicitly recited in the above description. No clause element is to be construed under the provisions of 35 U.S.C. § 112, sixth paragraph, unless the element is expressly recited using the phrase “means for” or, in the case of a method clause, the element is recited using the phrase “step for.”

While this specification contains many specifics, these should not be construed as limitations on the scope of what may be described, but rather as descriptions of particular implementations of the subject matter. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially described as such, one or more features from a described combination can in some cases be excised from the combination, and the described combination may be directed to a subcombination or variation of a subcombination.

The subject matter of this specification has been described in terms of particular aspects, but other aspects can be implemented and are within the scope of the following clauses. For example, while operations are depicted in the drawings in a particular order, this should not be understood as requiring that such operations be performed in the particular order shown or in sequential order, or that all illustrated operations be performed, to achieve desirable results. The actions recited in the clauses can be performed in a different order and still achieve desirable results. As one example, the processes depicted in the accompanying figures do not necessarily require the particular order shown, or sequential order, to achieve desirable results. In certain circumstances, multitasking and parallel processing may be advantageous. Moreover, the separation of various system components in the aspects described above should not be understood as requiring such separation in all aspects, and it should be understood that the described program components and systems can generally be integrated together in a single software product or packaged into multiple software products.

The title, background, brief description of the drawings, abstract, and drawings are hereby incorporated into the disclosure and are provided as illustrative examples of the disclosure, not as restrictive descriptions. It is submitted with the understanding that they will not be used to limit the scope or meaning of the clauses. In addition, in the detailed description, it can be seen that the description provides illustrative examples and the various features are grouped together in various implementations for the purpose of streamlining the disclosure. The method of disclosure is not to be interpreted as reflecting an intention that the described subject matter requires more features than are expressly recited in each clause. Rather, as the clauses reflect, inventive subject matter lies in less than all features of a single disclosed configuration or operation. The clauses are hereby incorporated into the detailed description, with each clause standing on its own as a separately described subject matter.

The clauses are not intended to be limited to the aspects described herein, but are to be accorded the full scope consistent with the language clauses and to encompass all legal equivalents. Notwithstanding, none of the clauses are intended to embrace subject matter that fails to satisfy the requirements of the applicable patent law, nor should they be interpreted in such a way.

1. A computer-implemented method, comprising:
identifying a functionality available during a session between a publishing server and a consumer, wherein the consumer communicates with the publishing server using a client device;
providing multiple digital contents by at least one third party to the publishing server for display to the consumer within the session, based on a session parameter;
providing, to the client device, a plugin script to display a digital content selected by the consumer from the multiple digital contents;
providing an interactive element in the digital content for selection by the consumer, the interactive element comprising a link to open a new tab in the client device; and
providing a token to the publishing server when the digital content has been viewed by the consumer in the client device.

2. The computer-implemented method of claim 1, wherein providing multiple digital contents comprises providing at least one of a banner image, a headline, a subline, an audio stream or a video stream.

3. The computer-implemented method of claim 1, wherein providing multiple digital contents comprises sorting the digital contents according to a likelihood that the consumer will view the digital content in full.

4. The computer-implemented method of claim 1, further comprising providing a token to a retailer who owns the digital content, indicative that the consumer has viewed the digital content.

5. The computer-implemented method of claim 1, further comprising providing a token to a retailer when the consumer activates the interactive element in the digital content.

6. The computer-implemented method of claim 1, wherein providing, to the client device, a plugin script to display a digital content selected by the consumer comprises providing a video control including a play button, a pause button, and a stop button.

7. The computer-implemented method of claim 1, wherein identifying a functionality available during a session between a publishing server and a consumer comprises identifying at least one of a mobile device application, a desktop application, or a browser application running in the client device.

8. The computer-implemented method of claim 1, further comprising updating an algorithm for selecting the digital contents with the session parameter when the consumer has viewed the digital content.

9. The computer-implemented method of claim 1, wherein the session parameter comprises a time, a season, and a demographic information about the consumer, and providing the digital content comprises selecting a media file based on the time, the season, and the demographic information about the consumer.

10. The computer-implemented method of claim 1, wherein the session parameter comprises a caption of a session context, and providing the digital content comprises searching for the digital content with the caption.

11. A system, comprising:
a memory storing multiple instructions; and
a processor configured to execute the instructions to cause the system to:
identify a functionality available during a session between a publishing server and a consumer, wherein the consumer communicates with the publishing server using a client device;
provide multiple digital contents by at least one third party to the publishing server for display to the consumer within the session, based on a session parameter;
provide, to the client device, a plugin script to display a digital content selected by the consumer from the multiple digital contents;
provide an interactive element in the digital content for selection by the consumer, the interactive element comprising a link to open a new tab in the client device; and
provide a token to the publishing server when the digital content has been viewed by the consumer in the client device.

12. The system of claim 11, wherein the digital content comprises a banner image, a headline, a subline, an audio stream or a video stream.

13. The system of claim 11, wherein to provide multiple digital contents the processor executes instructions to sort the digital contents according to a likelihood that the consumer will view the digital content in full.

14. The system of claim 11, wherein the processor further executes instructions to provide a token to a retailer who owns the digital content, indicative that the consumer has viewed the digital content.

15. A computer-implemented method, comprising:
identifying a user in a session with a publishing server;
selecting multiple advertisement payloads by at least one third party for the user, based on a purchasing history of the user stored in a database and on a session parameter;
determining a rank for the advertisement payloads on a likelihood that the user will consume an advertisement payload during the session;
forming a sorted list of advertisement payloads based on the rank and on the session parameter;
forming a control widget to enable the user handling of the advertisement payload; and
providing a digital content to a publisher server, the digital content including the sorted list of advertisement payloads, the control widget, and a plugin interactive element to link the user with a target website of an advertiser.

16. The computer-implemented method of claim 15, wherein the session parameter is indicative of whether the session is running a mobile application or a browser in a desktop device and selecting multiple advertisement payloads for the user comprises selecting the advertisement payloads for display in the mobile application or in the desktop device based on the session parameter.

17. The computer-implemented method of claim 15, wherein the session parameter is indicative of a display features in a client device handled by the user, and selecting multiple advertisement payloads for the user comprises selecting an advertisement payload that is compatible with the display features in the client device.

18. The computer-implemented method of claim 15, wherein forming the control widget comprises including an interactive element for display to the user, wherein the interactive element includes a link to a resource location for a vendor associated with the advertisement payload.

19. The computer-implemented method of claim 15, wherein the session parameter comprises a semantic context of the session, further comprising searching in a database for an advertisement payload based on the semantic context of the session.

20. The computer-implemented method of claim 15, further comprising configuring the plugin interactive element to provide a track signal indicative of an interaction between the user and the advertisement payload.
